(19) United States
(12) Patent Application Publication
(10) Pub. No.: US 2021/0107088 A1
(43) Pub. Date: Apr. 15, 2021

(54) PORTABLE INERTIA FRICTION WELDING SYSTEM AND METHOD

(71) Applicant: Edison Welding Institute, Inc., Columbus, OH (US)

(72) Inventor: Seth Shira, Columbus, OH (US)

(21) Appl. No.: 17/066,634

(22) Filed: Oct. 9, 2020

Related U.S. Application Data
(60) Provisional application No. 62/913,416, filed on Oct. 10, 2019.

(51) Int. Cl. B23K 20/12

(52) U.S. Cl. CPC B23K 20/1285; B23K 2101/26; B23K 20/1295

(57) ABSTRACT

A method for joining materials, comprising placing a first metal item within a spindle; rotating the spindle to a predetermined speed; contacting the first metal item with a second metal item to create friction between the first metal item and second metal item, wherein the second metal item has a known austenization temperature that is not crossed by the created friction; applying a predetermined amount of force through the spindle, wherein application of the force stops the rotation of the spindle and joins the first metal item with the second metal item; and retracting the spindle from the first metal item.

### CROSS-REFERENCE TO RELATED APPLICATIONS

This patent application claims the benefit of U.S. Provisional Patent Application Ser. No. 62/913,416 filed on Oct. 10, 2019 and entitled “Portable Inertia Friction Welding System”, the disclosure of which is hereby incorporated by reference herein in its entirety and made part of the present U.S. utility patent application for all purposes.

### BACKGROUND

The present invention relates generally to a system and method for joining two components to one another, particularly where one of the two components is a hardened metal, and more specifically to a system and method for attaching a stud or other appurtenance to a specific location on a length of steel rail for the purpose of attaching a signal wire to the stud.

Railroad signaling systems are essential for enabling safe and efficient movement of rail traffic. Many modern railroad signal systems employ a track circuit to detect the presence of a train within a section of track known as a signal block. A basic principle behind the track circuit involves the connection of the two rails by the wheels and axle of locomotives to short out an electrical circuit. This circuit is monitored by electrical equipment to detect the absence of the trains. An integral part of the track circuit is the two parallel running rails on which a train operates. Various types of signal devices are typically connected to these rails to complete the track circuit. Known techniques for connecting a wire to a rail include exothermic welding processes where the wire is welded to the rail. Other techniques include compressing a metal sleeve including the wire into a hole drilled in the rail or clamping the wire directly to the rail. Many signaling system incidents are known to be caused by failures at the rail-wire interface, where track wires, bond wires, or propulsion-current bond wires are attached to the rails to provide an electrical path for controlling train control signals. Such failures contribute to train delays and additional maintenance costs for emergency and unplanned repairs and are highly undesirable for these and other reasons.

As indicated above, signal wires are attached to rails to permit positive train control and to sense breaks in the rails for avoiding accidents. A reliable signal wire-to-rail connection is essential for signal system functionality and failures cause service disruptions and can affect the integrity of the rail, leading to rail failure. Known methods for attaching a signal wire to a length of track involve the use of an appurtenance or stud that is attached directly to the rail. A signal wire is then attached or connected to the stud. Common attachment methodologies include brazing, soldering, drilling, and/or clamping the stud/wire to the rail. Many brazing methods require preheating the rail section to which the stud will be attached and then precisely controlling the rate of rail cooling to avoid the undesirable formation of un-tempered martensite in the rail. With brazing methodologies there is also the risk of liquid metal embrittlement as the rail is under tensile stress to maintain neutral temperature and a liquid metal is present during the process.

Accordingly, it is a common precautionary practice to locate the studs at the neutral axis of the rail due to the possible formation of a brittle layer around the joint caused by overheating of the stud/wire to rail connection point. The placement of welds/braze joints on the head of the rail is known to result in the formation of martensite in the head of the rail which initiated cracks that led to several train derailments. Thus the neutral axis is generally safer from a catastrophic failure perspective. However, placement at this location makes the wire harnesses susceptible to snagging by maintenance equipment and the formation of martensite in this area may still lead to cracking and rail failure. Furthermore, most known attachment methodologies require a degree of operator skill, the absence of which may result in inconsistent or incorrect installations and ultimately in failure of the stud/wire connection, particularly in mass production. Thus, there is an ongoing need for an improved system and method for attaching a stud or appurtenance to a specific location on a length of steel rail.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation provides a first method for joining materials. This first method comprises placing a first metal item within a spindle; rotating the spindle to a predetermined speed; contacting the first metal item with a second metal item to create friction between the first metal item and second metal item, wherein the second metal item has a known austenization temperature that is not crossed by the created friction; applying a predetermined amount of force through the spindle, wherein application of the force stops the rotation of the spindle and joins the first metal item with the second metal item; and retracting the spindle from the first metal item. The first metal may be non-ferrous or brass; may be a hexagonal stud, a bolt, or a block; and may be an appurtenance to which a signal wire or other device may be attached. The predetermined rotational speed of the spindle may be within the range of 4000-7000 RPM. The spindle may have an internal mass between 0.01 and 2.0 WK². The second metal item may be steel and may be a length of train rail. The predetermined amount of force may be in the range of 1500 and 4000 lbf. The rotary power may be decoupled from the spindle within ±1 second after the first metal item contacts the second metal item.

Another implementation provides a second method for joining materials. This second method comprises placing a first metal item within a spindle, wherein the first metal item is non-ferrous, and wherein the first metal item is an appurtenance to which a signal wire or other device may be attached; rotating the spindle to a predetermined speed, wherein the predetermined rotational speed of the spindle is within the range of 4000-7000 RPM; contacting the first metal item with a second metal item to create friction between the first metal item and second metal item, wherein the second metal item has a known austenization temperature that is not crossed by the created friction; applying a predetermined amount of force through the spindle, wherein the predetermined amount of force is in the range of 1500 and 4000 lbf, and wherein application of the force stops the rotation of the spindle and joins the first metal item with the second metal item; and retracting the spindle from the first metal item. The first metal may be brass and may be a hexagonal stud, a bolt, or a block. The second metal item may be steel and may be a length of train rail.

Still another implementation provides a third method for joining materials. This third method comprises placing a first metal item within a spindle, wherein the spindle has an internal mass between 0.01 and 2.0 WK², wherein the first metal item is non-ferrous, and wherein the first metal item is an appurtenance to which a signal wire or other device may be attached; rotating the spindle to a predetermined speed, wherein the predetermined rotational speed of the spindle is within the range of 4000-7000 RPM; contacting the first metal item with a second metal item to create friction between the first metal item and second metal item, wherein the second metal item has a known austenization temperature that is not crossed by the created friction; applying a predetermined amount of force through the spindle, wherein the predetermined amount of force is in the range of 1500 and 4000 lbf., wherein application of the force stops the rotation of the spindle and joins the first metal item with the second metal item, and wherein rotary power is decoupled from the spindle within ±1 second after the first metal item contacts the second metal item; and retracting the spindle from the first metal item. The first metal item may be a brass hexagonal stud, bolt, or block. The second metal item may be steel and may be a length of train rail.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 is a side view of an example portable inertia friction welder mounted on a length of rail in accordance with one implementation of the disclosed systems, devices, and methods;

FIGS. 2A and 2B are front and side views respectively, of an example stud or appurtenance suitable for mounting on the length of rail shown in FIG. 1;

FIG. 3 depicts a high-magnification metallurgical section of a weld joint created by the disclosed systems, devices, and methods showing no apparent change to the underlying rail steel material;

FIG. 4 depicts a macro view of a weld stud mounted on rail material using the disclosed systems, devices, and methods;

FIG. 5 depicts an alternate implementation for attaching a stud to a rail section using the disclosed inertia friction welding systems, devices, and methods; and

FIG. 6 depicts another implementation of the disclosed systems, devices, and methods, wherein the inertia friction welding device has been modified to prepare the surface of a rail section prior to welding an appurtenance thereto.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter. The disclosed systems, devices, and methods are related to and compatible with the technologies described in U.S. Pat. Nos. 10,239,153 and 9,498,843, both of which are incorporated by reference herein in their entirety, for all purposes.

As previously described, implementations of the disclosed systems, devices, and methods are useful generally for joining two components to one another, particularly where one of the two components is a hardened metal, and more specifically to systems, devices, and methods for attaching a stud or appurtenance to a specific location on a length of steel rail for the purpose of attaching a signal wire to the stud. The disclosed technology has applicability beyond use with rails and signal wires because the process can also be used to attach appurtenances to hardenable materials without negatively affecting the underlying material properties. For example, attaching a bolt on location to a hardened cutting surface that is heat treated would be possible without deleterious effects to the pre-hardened material. Essentially, the system and method of this invention may be used for any number of applications that require the attachment of one metal component to another metal component wherein the use of more traditional joining or welding techniques would potentially damage the substrate metal. Using the system and method of this invention, the risk of liquid metal embrittlement and martensite formation are substantially eliminated because there is no melting of a stud or braze material to infiltrate grain boundaries in the steel, and because the welding temperature is kept below the critical transformation temperature of hardened steel. Various example implementations are described in greater detail below.

Implementations of the disclosed systems, device, and methods typically includes joining together two or more metal components using a welding technique that avoids damaging either component during the joining process. In one example implementation, the first component is a length of hardened steel rail used for train track. Modern track typically includes hot rolled steel having the profile of an asymmetrical rounded I-beam. Unlike some other uses of iron and steel, railway rails are subject to very high stresses and are typically made of very high quality steel alloy. Attachment of an appurtenance to heat-treated steel is typically very difficult due the nature of this alloy. The second component is a lower strength appurtenance such as a stud to which signal wire is or will be attached. This stud is joined to the steel rail at a desired location using a welding process, such as friction welding, which prevents the occurrence of liquid metal embrittlement in the rail alloy.

Friction welding is a solid-state welding process that generates heat through mechanical friction between a moving workpiece and a stationary component, with the addition of a lateral force called “upset” to plastically displace and fuse the materials. The combination of fast joining times (on the order of a few seconds), and direct heat input at the weld interface, yields relatively small heat-affected zones. Friction welding techniques are generally melt-free, which avoids grain growth in engineered materials such as high-strength, heat-treated steels. Another advantage of friction welding is that it allows dissimilar materials to be joined to one another. Normally, the wide difference in melting points of two dissimilar materials would make it nearly impossible to weld using traditional techniques and would require some sort of mechanical connection. Friction welding provides a “full-strength” bond with no weight being added to the weld joint.

With regard to steel rail components, the system, device, and method of the present invention produces a weld on rail steel without crossing the known austenitization temperature for such steel, thereby avoiding the need for tempering post weld or controlled cooling to avoid martensite formation. Austenitization involves heating iron, an iron-based metal, or steel to a temperature at which it changes crystal structure from ferrite to austenite. Martensite refers to a very hard form of steel crystalline structure and is formed by rapid cooling (quenching) of austenite which traps carbon atoms that cannot diffuse out of the crystal structure. This martensitic reaction begins during cooling when the austenite reaches a known martensite start temperature and the parent austenite becomes mechanically unstable. Since quenching can be difficult to control, many steels are quenched to produce an overabundance of martensite and then tempered to gradually reduce its concentration until the right structure for the intended application is achieved. Too much martensite leaves steel brittle, too little leaves it soft. With regard to an appurtenance or stud component, certain materials (e.g., low-sulfur, low-lead alloys) exhibit highly desirable characteristics, which permit friction welding of the stud to the rail without a temperature in excess of the austenitization temperature of the rail or steel without demanding thrust loads that are too high for a portable inertia welding system. In general, the use of a hexagonal shaped stud with a circular face minimizes machining cost for the stud and provides wrench flats during in-service work.

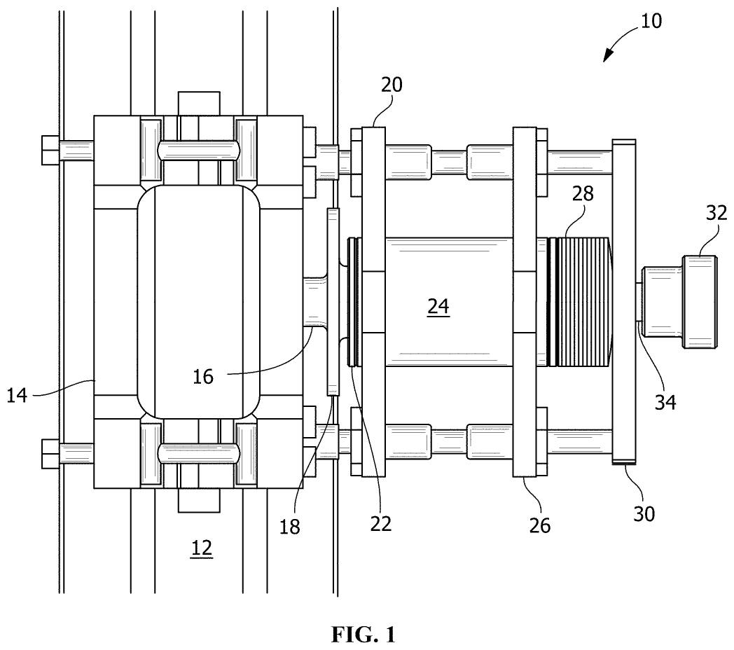

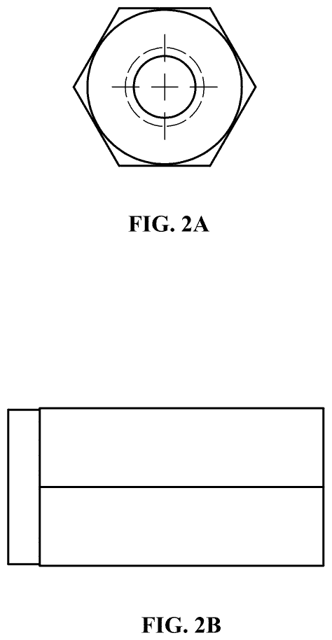

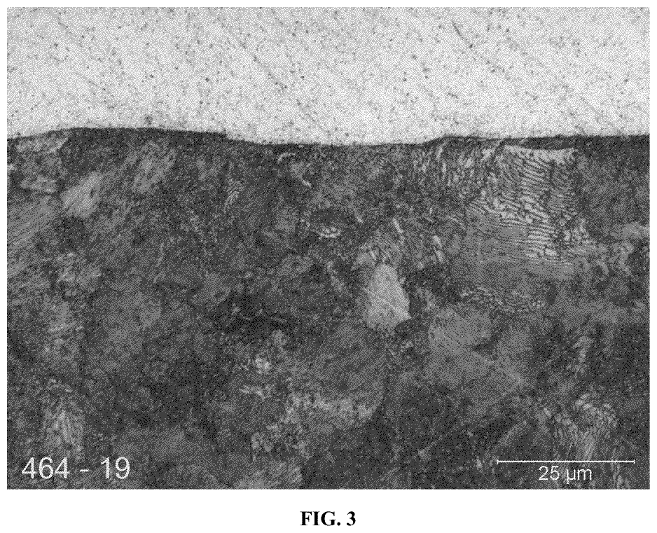

One implementation utilizes a portable battery-powered inertia friction welder that is mounted on a length of rail for low-energy input welding. The use of a low mass flywheel coupled with high surface velocity allows for a lightweight portable unit. The controls for speed and thrust load control are specific to the machine tool mounted to the rail. The use of a preloaded spring assembly or a pre-charged air or hydraulic cylinder provides weld force/thrust load in the portable system and a pin/ball release holds the thrust load on the spring. A lightweight clamp attaches the system to the head of the rail and a locator placed under the ball of the rail ensures repeatable placement on the rail regardless of wear condition. Location for the stud is dictated by reference to the under head radius region that transitions into the web of the rail. This configuration allows for reliable installation of studs with little operator influence on the process as all critical parameters are predetermined and mechanically controlled. As shown in FIG. 1, an exemplary embodiment of welding system 10 includes a length of rail 12 upon which restraining clamp 10 is mounted. Chuck 16 houses the stud (see FIGS. 2A-2B) or other appurtenance, and flywheel 18 is connected to chuck 16. Front mount guide plate 20 supports bearing end plate 22, which is connected to bearing assemblies 24 which provide motor decouple and force engagement control. Rear mount guide plate supports bearing assemblies 24 and spring pack 28, which includes an air cylinder for providing thrust load. Motor coupler 32 is connected to drive shaft 34, which passes through back up plate 30 and connects with spring pack 28.

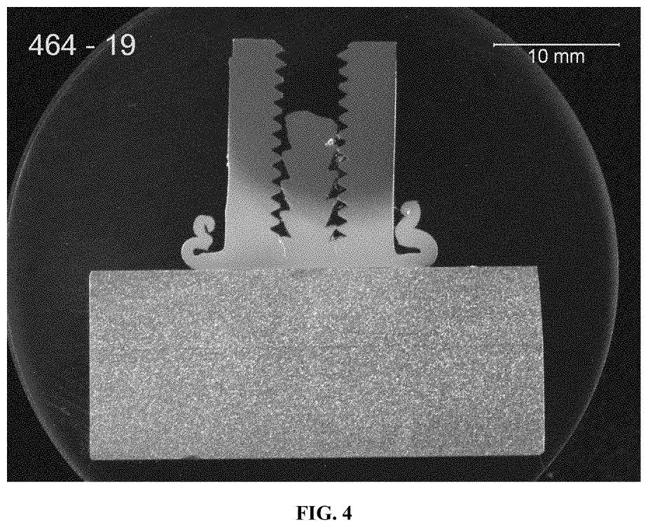

In accordance the disclosed systems, devices, and methods, welds may be produced using an portable inertia friction welding machine such as that disclosed in U.S. Pat. No. 6,779,709 (Stotler et al.), which is incorporated by reference herein, in its entirety, for all purposes. The device disclosed in U.S. Pat. No. 6,779,709 is referred to as the m120 inertia friction welder and is a stationary programmable inertia friction welding machine that is capable of varying thrust load from 2000 lbs. to 24,000 lbs., varying rotating mass from 1.21 wk² to 19 wK², and varying initial spindle speed from 300 to 13,000 RPM. This device typically uses collet type clamps to hold parts and or tooling in the headstock and tailstock. Additionally, surface velocity, thrust load, and inertia may be varied to control heat input. Suitable alloys for the appurtenance (i.e., stud) include low-sulfur, low-lead alloys generally and C464 Naval Brass, C172 Class 4 copper, C260 Brass, Muntz Metal (National Bronze and Metals, Houston, Tex.; Southern Copper, Pelham, Ala.) and Ni-12P braze alloy, specifically. Studs such as that shown in FIGS. 2A-2B, can be made from ½-in hex stock to allow for easy torsion energy delivery and to simplify production. Weld strengths may approach 6000 pounds for the hex parts welded, which is roughly 35 ksi tensile strength or 50% of the cold worked C464 brass. With a hex stud design, a speed of 4000-4500 rpms, an inertial mass of 1.21 WK², and a thrust load of 5200-lbs force to 6000-lbs force may be employed with work hardened Naval Brass. FIGS. 3-4 depict metallographic and SEM analysis conducted on weld joints to verify that no martensite was formed because the critical temperature in the steel was not exceeded during welding. Studs or appurtenances pre-tinned with an alloy to create a solid state braze joint such as 50/50 Pb—Sn solder, are also compatible with this invention. As will be appreciated by one of ordinary skill in the art, the process of friction welding is scalable based on variables such as the surface area and mean diameter of the appurtenance (i.e., second component).

Advantageously, the disclosed systems, devices, and methods permit the installation of signal wires and studs on the head of the rail without causing deleterious effects to the underlying rail material, i.e., brittleness and other weaknesses do not occur (see FIGS. 3-4). As previously stated, signal wires are typically located on the neutral axis of the rail making these connections susceptible to damage by maintenance equipment that snags and breaks studs and wiring located on the web neutral axis of the rail. Thus, the point of attachment may be moved from a low stress area to a critically loaded area (i.e., high stress area) without creating noticeable changes in the microstructure of the underlying alloy or problems with the integrity and strength of underlying substrate metal.

Certain aspects the disclosed systems, devices, and methods permit real-time quality validation of martensite-free attachment of studs (or other appurtenances) to rail sections. As previously indicated, the rail industry uses brazing methodologies for joining wires to rails sections for signaling and electrical conduction. While the disclosed systems, devices, and methods permit using inertia friction welding to attach items to a rail surface, the quality and effectiveness of these methods can be dependent on operator skill and performance. Therefore, real-time quality control is important to users of the rail-wire interface created by the disclosed technology. While using inertia friction welding, certain predetermined inputs and outputs from the attachment process can be measured and the data gathered from such measurements can be analyzed using various processors incorporated into or associated with the relevant equipment and the process/method itself. The resulting analysis accurately predicts the quality of the weld based on measured process characteristics. In one implementation, a displacement monitor is used during inertia friction welding of a stud to rail section for measuring total upset distance. In another implementation, a tachometer is used during inertia friction welding of a stud to rail section to measure starting speed RPM's and real time speed decay. In still another implementation, one or more small electronic devices are placed on the portable inertia for validating weld quality. These devices may measure, for example, initial RPM's speed, total upset distance, peak upset distance velocity, time of deceleration to zero RPM's, and use of a polynomial mathematic equation in the system processor to validate weld quality.

Certain aspects the disclosed systems, devices, and methods permit various design modifications with regard to the specific attachment of a stud to a rail section using inertia friction welding. As previously indicated, current rail to wire interfaces may involve a braze weld or solder joint to attach a signal wire to a rail section. These approaches are used to overcome corrosion issues experienced when a clamped joint becomes loose, thereby allowing corrosion to enter the electrical conduction path. The use of a weld joint that incorporates a stud weld (using either a female or a male stud) prevents corrosion from occurring at any significant level between the rail and the attachment point of the stud. Selection of an appropriate stud material, such as Naval Brass, minimizes any potential risk of galvanic corrosion from occurring.

Solder joints or braze joints also require that a signal wire be cut to remove the wire bundles for maintenance which shortens the wires and greatly limits reuse thereof. The disclosed inertia friction welding systems, devices, and methods for attaching a stud to a rail section permits a corrosion resistant alloy to be welded onto the rail section, thereby eliminating corrosion concerns because the integrity of the inertia friction weld prevents the formation of crevices. Possible design modifications permit threads to be included on the stud for facilitating multiple signal wire installation and de-installation cycles. This feature significantly simplifies removal of signaling and detection wires from the rail when maintenance of way (MOW) work is undertaken. This approach also reduces cost due to reduced materials utilization and eliminating the need to place additional welds on the rail every time a signal wire change is required. Further improvements to stud design include using the male stud to allow for a weld joint larger in diameter than the stud itself to be produced, thereby adding strength and mechanical advantages to the welded stud and increasing its resistance to breakage while in service.

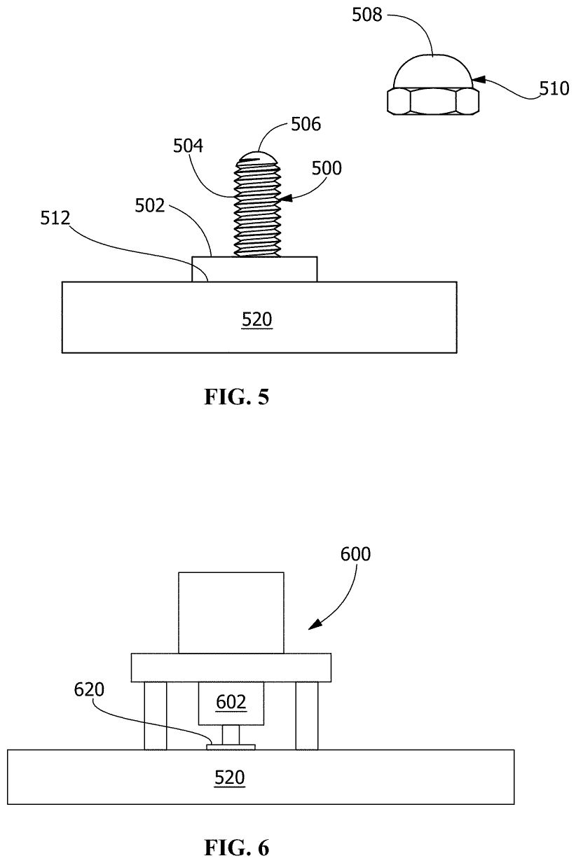

Based on the foregoing and with reference to FIG. 5, various design modifications concerning the specific attachment of a stud to a rail section using inertia friction welding contemplated by the disclosed systems, devices, and methods include: (i) utilizing a threaded stud welded to the rail section as the rail-wire interface attachment point without the creation of a crevice corrosion concern; (ii) using Naval Brass as the stud alloy for eliminating corrosion and galvanic concerns; (iii) leaving a flat surface on the stud with a diameter greater than the threaded section of the stud for electrical connection and application of thrust loading during the friction welding process; (iv) placing drive features on the outer diameter of the stud at its larger diameter area to allow for transfer of torque during the friction welding process; (v) minimizing the stud length (e.g., less than 13 mm) to reduce the risk of wire and stud snags during MOW activity; (vi) placing a rounded end on the distal end of the stud to allow for centering in the inertial friction welding machine chuck and minimizing snag risk during MOW activities; (vii) placing a rounded or radius feature on the nut used to clamp wires onto the stud to reduce snags and loading during MOW activities; and (viii) making the weld interface between the rail and stud as a hollow tubular design having a diameter greater than that of the stud.

Certain aspects the disclosed systems, devices, and methods also provide a surface preparation system and method for use with a portable inertia friction welding system. Currently, the rail industry conducts upstream operations to properly prepare dissimilar weld joints for a creating weld between markedly different materials. As many of the relevant parts are portable and can be easily processed upstream, this processing is not typically difficult. However, when welding a stud to a rail section, the rail material is usually firmly attached to the ground and cannot be easily surfaced without extreme effort and extra tooling and processes. Accordingly, the approach disclosed herein uses the already present inertia friction welding machine to set the plane and axis of rotation when the welding machine is fixed to the rail section. A sander, grinder, or cutter is then placed in the chuck of the machine to create normality between the rail surface and machine axis (see FIG. 6).

Prior to making a martensite-free weld of a stud to a rail section, the axis of the stud or attachment axis of rotation must be made perpendicular to the surface plane of the rail section. Additionally, the rail surface must be cleaned and most irregularities should be removed to create surface conditions conducive to inertia friction welding. Creating axial alignment is based on the hardness difference between the rail steel and the stud alloy which is much softer and weaker. Axial alignment allows the stud to accommodate all the upset. If this upset occurs in a non-aligned condition, then the welder will not produce a full circumferential weld. This problem is typically solved by rotating the harder material in the dissimilar friction welding operation to set the plane with the hard material. Because this approach is not compatible with the welding method disclosed herein, this invention uses a hard abrasive or cutting device, inserted into the welder to reset the plane of the part to part interface. This simplifies set-up by creating a “perfect” plane with the sanding disk or cutting tool that is normal with the rotation axis. Research was conducted to establish the alignment requirements for the C464 Naval Brass stud to rail steel inertia friction welding joint. The results indicated that the desired axial alignment was within 0.5 degrees. A tool was built to be held in the welding machine and set a plane during welder rotation. This was tested by making welds on the surface and testing their strength. The strength was consistent, and no gaps were found circumferentially in the weld.

Based on the foregoing and with reference to FIG. 6, the rail surface preparation methods contemplated by the present invention include: (i) using a removable tool placed in the welder chuck to face the weld surface to create a plane that is normal to the axis of rotation in the welder; (ii) fixing the axial alignment of the friction weld joint with the friction welder to allow rotation of the softer material rather than the harder material; (iii) eliminating the need for special upstream processing of the surfaces prior to friction welding; (iv) the use of the friction welding system to prepare the surface for welding; and (v) allowing a different set of force and speed parameters to be used for sanding or surface preparation versus the welding operation itself.

As previously discussed, example implementations of the disclosed systems, devices, and methods are useful for attaching electrical terminals to steel structures and other metal components, and such electrical connections may be used for signal conduction from a structure for determining if any breaks or faults have occurred within the structure. This type of electrical connection may also be used to ground electrical systems or to conduct power to a specific device, such as an electric motor. As previously discussed, prior art systems make these types of connections by drilling holes in a structure and then bolting an electrical terminal in place or by using joining processes that have a detrimental effect by overheating the steel included in a structure of interest. In contrast, the disclosed systems, devices, and methods may be used to attach electrical terminals to steel structures at a temperature below the temperature range that creates martensite in the steel structure. As with the other implementations described above, the disclosed systems, devices, and methods may be used to attach non-ferrous studs or blocks to rail sections for creating signal wire connections. This system may also be used to attach non-ferrous studs or blocks to rail sections for traction bond leads in electric rail applications and may also be used to attach non-ferrous studs or blocks to steel structures for connecting grounding leads thereto.

Using a portable device basically the same as or similar to the device depicted in FIG. 1, another example implementation provides a friction-based solid state welding method for attaching non-ferrous studs or blocks to rail sections. This alternate system employs a solid-state process which uses friction as the source of heat to create a bond between a non-ferrous stud or block and a steel structural member; however, as with the other disclosed methods, the heat generated is insufficient to create martensite in the steel microstructure. This portable system may be deployed in the field for creating signal wire connections on steel structures rather than applying studs or blocks to steel components in a factory setting for installation in the field at a later time.

In an example method, a clamp (e.g., clamp 10) is attached to a steel structure (e.g., rail 12) to which a stud, block, or other item (see, e.g., FIGS. 2A-2B) is to be attached. A welding apparatus or weld head is affixed to the clamp, and a rotating spindle (e.g. chuck 16 or any other suitable holding device) and flywheel (e.g., flywheel 18) are mounted within the weld head. The rotating spindle is powered by an electric or pneumatic motor, an internal combustion engine, other suitable apparatus, and a controller is included for determining the sequence of operating events and various operational parameters. During the welding process, the spindle, which may have an inertial mass between 0.01 and 2.0 WK², is used to rotate a non-ferrous stud or block housed within the spindle to a pre-weld speed of 4000-7000 RPM prior to the stud or block being brought into contact with the steel structure with which it will be joined. The stud or block is then brought into contact with the steel structure and force is applied through the spindle by pressing the stud or block into the steel structure using force in a range of between 1500 and 4000 lbf. Force may be generated by hydraulic or pneumatic cylinders or spring(s) or a combination thereof. Rotary power is decoupled from the spindle within ±1 (one) second after the stud or block contacts the steel structure to which the stud or block is now attached. The spindle is then retracted and disengaged from the stud or block, thereby completing the welding process. In summary, during this welding process: (i) the spindle spools up to the controller designated speed (RPM); (ii) force is applied, thereby contacting the stud or block with the steel structure; (iii) friction between the stud and steel generates heat creating the weld and stopping the spindle rotation; and (iv) the weld head is pulled back, thereby disengaging the weld head from the stud.

In various experiments using the disclosed friction-based welding system, a test spindle and flywheel had an inertial mass of about 0.036 WK² and successful welds were made at about 5400 RPM and about 3000 lbf. An example suitable stud material was brass. Weld strength was tested by applying a torque load to hex shaped brass studs until failure. The initial torque load was small (˜20 ft-lbf) and was increased by 5 ft-lbf until either the stud twisted off, failing at the weld interface, or the hex geometry of the stud or block was rounded. An average twist off torque was determined to be near 50 ft-lbf. These experiments demonstrated that the disclosed method could be successfully used to create acceptable welds between non-ferrous items to steel substrates.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A method for joining materials, comprising:
(a) placing a first metal item within a spindle;
(b) rotating the spindle to a predetermined speed;
(c) contacting the first metal item with a second metal item to create friction between the first metal item and second metal item, wherein the second metal item has a known austenization temperature that is not crossed by the created friction;
(d) applying a predetermined amount of force through the spindle, wherein application of the force stops the rotation of the spindle and joins the first metal item with the second metal item; and
(e) retracting the spindle from the first metal item.

2. The method of claim 1, wherein the first metal item is non-ferrous.

3. The method of claim 1, wherein the first metal item is brass.

4. The method of claim 1, wherein the first metal item is a hexagonal stud, a bolt, or a block.

5. The method of claim 1, wherein the first metal item is an appurtenance to which a signal wire or other device may be attached.

6. The method of claim 1, wherein the predetermined rotational speed of the spindle is within the range of 4000-7000 RPM.

7. The method of claim 1, wherein the spindle has an internal mass between 0.01 and 2.0 WK².

8. The method of claim 1, wherein the second metal item is steel.

9. The method of claim 1, wherein the second metal item is a length of train rail.

10. The method of claim 1, wherein the predetermined amount of force is in the range of 1500 and 4000 lbf.

11. The method of claim 1, wherein rotary power is decoupled from the spindle within ±1 second after the first metal item contacts the second metal item.

12. A method for joining materials, comprising:
(a) placing a first metal item within a spindle, wherein the first metal item is non-ferrous, and wherein the first metal item is an appurtenance to which a signal wire or other device may be attached;
(b) rotating the spindle to a predetermined speed, wherein the predetermined rotational speed of the spindle is within the range of 4000-7000 RPM;
(c) contacting the first metal item with a second metal item to create friction between the first metal item and second metal item, wherein the second metal item has a known austenization temperature that is not crossed by the created friction;
(d) applying a predetermined amount of force through the spindle, wherein the predetermined amount of force is in the range of 1500 and 4000 lbf, and wherein application of the force stops the rotation of the spindle and joins the first metal item with the second metal item; and
(e) retracting the spindle from the first metal item.

13. The method of claim 12, wherein the first metal item is brass.

14. The method of claim 12, wherein the first metal item is a hexagonal stud, a bolt, or a block.

15. The method of claim 12, wherein the second metal item is steel.

16. The method of claim 12, wherein the second metal item is a length of train rail.

17. A method for joining materials, comprising:
(a) placing a first metal item within a spindle, wherein the spindle has an internal mass between 0.01 and 2.0 WK², wherein the first metal item is non-ferrous, and wherein the first metal item is an appurtenance to which a signal wire or other device may be attached;
(b) rotating the spindle to a predetermined speed, wherein the predetermined rotational speed of the spindle is within the range of 4000-7000 RPM;
(c) contacting the first metal item with a second metal item to create friction between the first metal item and second metal item, wherein the second metal item has a known austenization temperature that is not crossed by the created friction;
(d) applying a predetermined amount of force through the spindle, wherein the predetermined amount of force is in the range of 1500 and 4000 lbf, wherein application of the force stops the rotation of the spindle and joins the first metal item with the second metal item, and wherein rotary power is decoupled from the spindle within ±1 second after the first metal item contacts the second metal item; and
(e) retracting the spindle from the first metal item.

18. The method of claim 17, wherein the first metal item is a brass hexagonal stud, bolt, or block.

19. The method of claim 18, wherein the second metal item is steel.

20. The method of claim 18, wherein the second metal item is a length of train rail.
